(19) United States
(12) Patent Application Publication
(10) Pub. No.: US 2007/0029415 A1
(43) Pub. Date: Feb. 8, 2007

(54) Cart having a spreader

(76) Inventors: Neil Edwin Bowsher, Sullivan, IL (US); Ronald J. Hickenbottom, Sullivan, IL (US)

Correspondence Address: VEDDER PRICE KAUFMAN & KAMMHOLZ, 222 N. LASALLE STREET, CHICAGO, IL, 60601, US

(21) Appl. No.: 11/185,416

(22) Filed: Jul. 20, 2005

(51) Int. Cl. A01C 15/00

(52) U.S. Cl. 239/661; 239/657; 239/668; 239/663

(57) ABSTRACT

An attachment for a cart having a definable compartment includes a spreader compartment having an open bottom portion, a spreader device disposed in the bottom portion, and at least one spreader wheel coupled to the spreader device. The spreader compartment is adapted for attachment to a rear end of the cart to provide a contiguous compartment defined by the cart compartment and the spreader compartment.

### FIELD OF THE DISCLOSURE

The present disclosure generally relates to dump carts and spreaders, and more particularly, to a cart having a spreader.

### BACKGROUND

Utility carts are used in a variety of applications in commercial and residential settings. For example, utility carts are typically used to transport soil, mulch, fertilizer and the like in agricultural and residential garden settings. Such utility carts typically have a tongue that can be attached to the back end or hitch of a vehicle, such as a tractor or a riding lawn mower. Accordingly, the cart can be transported by the vehicle. Additionally, utility carts may be pivotable so that the contents thereof can be dumped from the back end when desired.

In the above-described garden or agricultural settings, it may be necessary to spread the contents of the cart in an area. Accordingly, an operator may have to dump the contents on the ground and then spread the contents in a desired area. Alternatively, the operator of the cart would have to transfer the contents from the cart to a spreader for spreading the contents in the area.

Therefore, there exists a need in the art for a cart that includes a spreader, or a spreader attachment that can be used on a typical utility cart to spread the contents of the cart.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 illustrates a perspective view of a cart having a spreader constructed in accordance with the teachings of the present disclosure;

FIG. 2 illustrates an exploded view of the spreader of FIG. 1;

FIG. 3 illustrates the cart of FIG. 1 in a spreading position; and

FIG. 4 is a top perspective view of a portion of the spreader of FIG. 1.

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated device and such further applications are the principles disclosed as illustrated therein as being contemplated as would normally occur to one skilled in the art to which this disclosure relates.

In accordance with a principal aspect of the present disclosure, an attachment for a cart having a definable compartment includes a spreader compartment having an open bottom portion, a spreader device disposed in the bottom portion, and at least one spreader wheel coupled to the spreader device. The spreader compartment is adapted for attachment to a rear end of the cart to provide a contiguous compartment defined by the cart compartment and the spreader compartment.

In accordance with another principal aspect of the present disclosure, a cart includes a cart compartment and a spreader compartment disposed at a rear portion of the cart compartment. The spreader compartment includes an open bottom portion extending a width of the spreader compartment, a spreader device disposed in the bottom portion, and at least one spreader wheel having a plurality of radial spikes and coupled to the spreader device. The cart further includes a cart axle having at least a pair of cart wheels to moveably support the cart compartment and the spreader compartment on the ground, the cart compartment and the spreader compartment being movable about the axle.

In accordance with another principal aspect of the present disclosure, an attachment for a cart having a cart compartment with an openable rear end includes a spreader compartment defined by a pair of opposed side walls, each side wall having a rear portion and a front portion, and a back wall extending between the rear portions of the side walls. The attachment further includes a spreader drum disposed in the bottom portion and rotatably coupled to the side walls, and a pair of spreader wheels, each spreader wheel coupled to an end of the drum. The front portions of the side walls are configured to couple to a rear end of the cart to provide a contiguous compartment defined by the cart compartment and the spreader compartment when the rear end of the cart is opened.

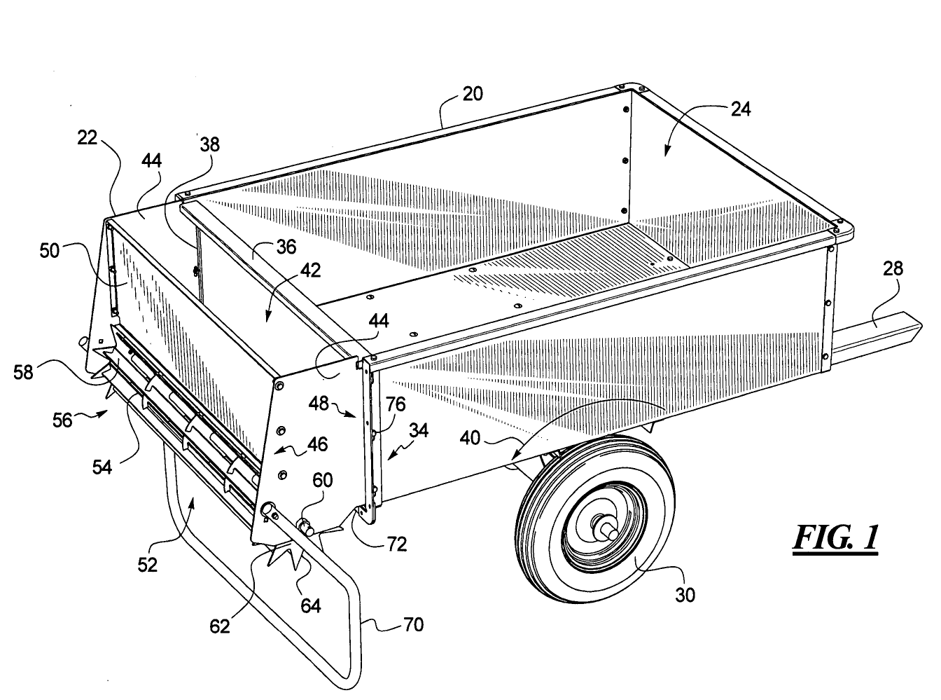

Referring to FIG. 1, a cart 20 having a spreader 22 constructed in accordance with the teachings of the present disclosure is shown. The spreader 22 may be integrally constructed with the cart 20. Alternatively, the spreader 22 may be attachable to the cart 20 as an accessory. As will become apparent from the following, the spreader 22 can provide spreading of the contents of the cart 20 on the ground with movement of the cart 20.

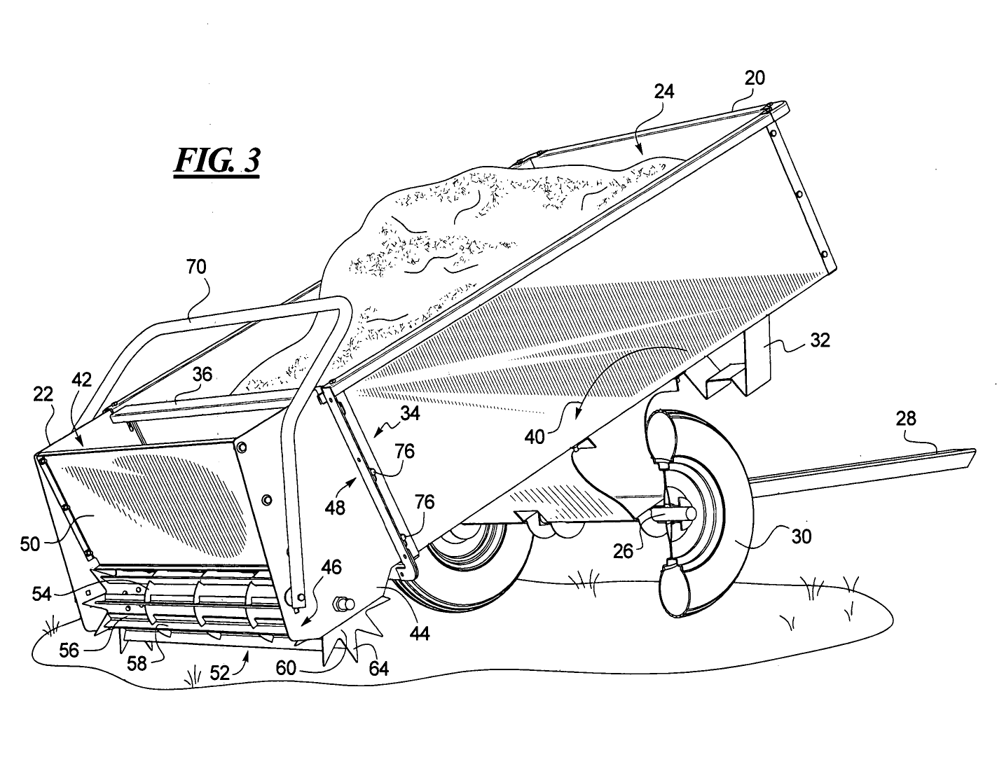

Referring to FIGS. 1-4, the cart 20 includes a cart compartment 24 that is pivotally supported on an axle 26. The cart 20 may include a frame (not shown) that supports the axle 26 such that the axle 26 can rotate relative to the frame. A tongue 28 defines part of the frame and is disposed in front of the cart 20. The front portion of the tongue 28 includes provisions (not shown) for attaching the cart to a hitch or a rear frame of a vehicle which can pull or push the cart 20. Rotatively attached to the axle 26 are a pair of wheels 30 that provide movement of the cart 20 over the ground when the cart is being pulled or pushed by a vehicle. Beneath the front portion of the cart compartment 24, a front support 32 (shown in FIG. 3) rests on the tongue 28 to maintain the cart component 24 at a substantially level position. Additionally, the front support 32 and the tongue 28 may have a releasable lock mechanism (not shown) that can secure the front support 32 to the tongue 28 and release the front support 32 from the tongue 28 when desired.

The rear end 34 of the cart 20 includes a lift gate 36 that slides vertically in a pair of laterally opposed lift gate guides 38. Accordingly, an operator can slide the lift gate 36 in the lift gate guides 38 to open and close the rear end of the cart 34 when desired. For example, when the cart 20 is loaded with material and the material is being transported from one location to another, the lift gate 36 can remain closed so that the material in the cart 20 does not spill out. The cart compartment 24 is pivotable relative to the axle 26 as shown by the arrow 40. Accordingly, when the contents of the cart compartment 24 are to be dumped, the lift gate 36 can be pulled out of the lift gate guides 38 as far as necessary, or pulled out completely. The cart compartment 24 can then be rotated in the direction of the arrow 40, thereby causing the contents of the cart to be dumped from the rear end 34 of the cart 20.

As described in the foregoing, the spreader 22 can be integrally formed with the cart 20 or be attached to the cart 20 to form a spreader compartment 42 at the rear portion of the cart 20. The lift gate 36 is disposed between the cart compartment 24 and the spreader compartment 42. Accordingly, for the contents of the cart compartment 24 to be transferred to the spreader compartment 42, the lift gate 36 has to be partially opened or completely removed.

The spreader 22 includes a pair of sidewalls 44, each of which has a rear portion 46 and a front portion 48. The spreader 22 also includes a back wall 50 that extends between the rear portions 46 of the sidewalls 44 to close the rear end of the spreader 22. The spreader 22 also includes a bottom portion 52 that may be fully or partially open. The bottom portion 52 may be fully or partially open so that the contents of the cart compartment 24 and the spreader compartment 42 can be spread onto the ground through the bottom portion 52.

A spreader device 54 is disposed in the bottom portion 52 and provides spreading of the materials in the cart compartment 24 and the spreader compartment 42. The spreader device 54 may be any type of spreading device that is known in the art. In the disclosed examples, the spreader device 54 includes a spreader drum 56 that is defined by a plurality of spreader blades 58. The spreader drum 56 includes a spreader drum shaft 60 that extends longitudinally through the spreader drum 56. The ends of the spread shaft 60 are rotationally mounted to the side walls 44 of the spreader 20. Accordingly, the spreader drum 56 is rotationally disposed in the bottom portion 52. In the disclosed examples, the spreader drum 56 is sized so as to substantially fill the width of the bottom portion 52. Additionally, the spreader drum 56 can freely rotate with the spreader shaft 60 relative to the side walls 44.

The spreader 22 also includes at least one spreader wheel 62 that provides rotation of the spreader drum 56 when the cart 20 is placed in the spreading position as will be described in the following. In the disclosed examples, the spreader 22 includes a pair of spreader wheels 62 that are disposed at the opposing ends of the spreader drum 56. Rotation of the spreader wheels 62 causes rotation of the spreader shaft 60, thereby causing the rotation of the spreader drum 56. Each spreader wheel 62 includes a plurality of radial spikes 64 that provide traction for the spreader wheel 62.

To operate the spreader 22, an operator can first pivot the cart relative to the axle 26 so that the spreader wheels 62, and more particularly the spikes 64 contact the ground. The pivoted position of the cart 20 as shown in FIG. 3 is referred to herein as the spreading position. The operator, who may be in a vehicle that is pulling the cart 20, can either stop the vehicle and manually pivot the cart compartment 24 about the axle 26 or use a lever (not shown) installed in the vehicle to pivot the cart 20. The lever can be connected to the cart 20 by a number of cables, rigid links, and/or the like. Accordingly, when the operator triggers the lever, the front support 32 is lifted from the tongue 28 so that the cart compartment 24 pivots about the axle 26. When the spreader wheels 62 contact the ground, the spikes 64 penetrate the ground. When the tongue 28 is pulled by the vehicle to which the cart 20 is attached, the spreader wheels 62 rotate, thereby rotating the spreader drum 56.

In the spreading position, the material that is stored in the cart compartment 24 and the spreader compartment 42 can contact the spreader drum 56 through the bottom portion 52. An apron 65 is disposed between the cart compartment 24 and the spreader compartment 42 to close the gap therewith and to prevent the contents of the cart 20 from spilling onto the ground through the gap. As the spreader wheels 62 turn to thereby turn the spreader drum 56, the material that is inside the cart compartment 24 will fall through the bottom portion and contact the blades of 58 of the spreader drum 56. Rotation of the spreader blades 58 has the effect of distributing the contents of the cart 20 along the bottom portion 52 as the contents fall through the bottom portion 52. Accordingly, the materials from the cart compartment 24 can be spread substantially evenly onto the ground from the bottom portion 52.

When the operator of the cart 20 wishes to the stop spreading of the material from the cart compartment 24 through the spreader 22, the operator can simply stop the movement of the cart 20. The operator can then pivot the cart 20 back to a level position and transport the cart 20 to another location without performing any spreading operation. To maintain the cart compartment 24 and the spreader compartment 42 at a level position when the cart 20 is stationary, the spreader 22 can include a stand 70 that is pivotally mounted to the side walls 44 such that it can be retracted and deployed relative to the spreader 22. As shown in FIG. 1, the stand 70 is sized such that when deployed it maintains the cart 20 at a level position. When the operator of the vehicle wishes to pivot the cart, the operator must retract the stand 70 as shown in FIG. 3.

As described in the foregoing, the operator of the cart 20 may have to pivot the cart compartment 42 manually or with a lever installed in the vehicle. In yet another example of the present disclosure, the center of gravity of the cart 20 with the spreader 22 can be behind the axle 26 such that when the stand 70 is retracted the cart 20 naturally pivots about the axle in the direction of the arrow 40. Accordingly, the operator can pivot the cart 20 simply by retracting the stand 70 to cause the natural pivoting the cart about the axle 26.

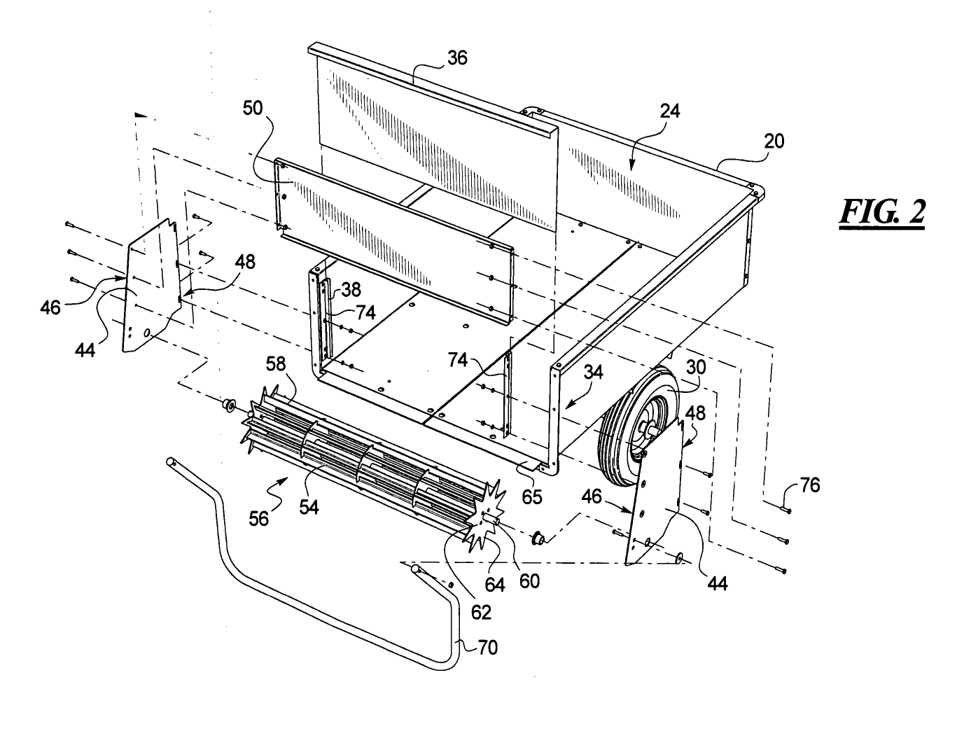

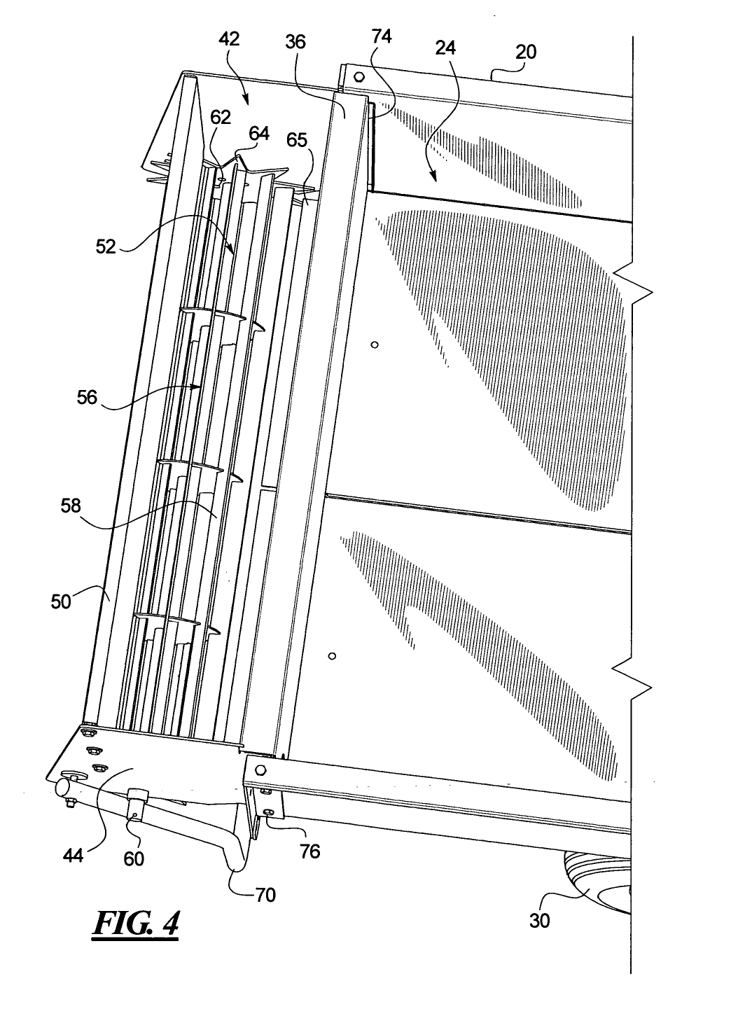

As described in the foregoing, the spreader 22 can be integrally formed with the cart 20 such that the cart includes a unitary compartment including a cart compartment 24 and the spreader compartment 42 that can be separated or connected with the lift gate 36. However, as also described in the foregoing, the spreader 22 can be an attachment 22 and can be attached to a variety of utility carts 20 that are commonly used in various applications. To install the spreader 22 on a cart 20, the front portions 48 of the side walls 44 can be aligned with a rear end 34 of the cart 20. The cart 20, the spreader 22, and/or both can include flanges, adaptors, or the like to facilitate the removable attachment of the spreader 22 to the cart 20. In one example, as shown in FIGS. 2 and 4, the cart 20 includes flanges 74 having a plurality of apertures that can align with a plurality of corresponding apertures at the rear end 34 of the cart 20 such that each aperture can receive a fastener 76 (shown in FIGS. 1-4) to fasten the spreader attachment 22 to the cart 20. As shown in FIG. 2, the flanges 74 also function as the lift gate guides 38.

Furthermore, while the particular preferred embodiments have been shown and described, it will be obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. An attachment for a cart having a definable compartment, the attachment comprising:
a spreader compartment having an open bottom portion;
a spreader device disposed in the bottom portion;
at least one spreader wheel coupled to the spreader device; and
wherein the spreader compartment is adapted for attachment to a rear end of the cart to provide a contiguous compartment defined by the cart compartment and the spreader compartment.

2. The attachment of claim 1, comprising at least a second spreader wheel defining a pair of spreader wheels with the at least one spreader wheel, wherein each spreader wheel is coupled to the spreader device.

3. The attachment of claim 1, wherein the spreader wheel comprises a plurality of radial spikes.

4. The attachment of claim 1, wherein the spreader device comprises a spreader drum extending a width of the bottom portion and rotatably disposed in the bottom portion.

5. The attachment of claim 4, wherein the spreader drum is defined by a plurality of radially spaced apart and laterally extending spreader blades.

6. The attachment of claim 1, further comprising a retractable stand.

7. The attachment of claim 1, further comprising an apron disposed between a floor of the cart compartment and the bottom portion of the spreader compartment.

8. A cart comprising:
a cart compartment;
a spreader compartment disposed at a rear portion of the cart compartment, the spreader compartment comprising:
an open bottom portion extending a width of the spreader compartment;
a spreader device disposed in the bottom portion; and
at least one spreader wheel having a plurality of radial spikes and coupled to the spreader device; and
a cart axle having at least a pair of cart wheels to moveably support the cart compartment and the spreader compartment on the ground, the cart compartment and the spreader compartment being movable about the axle.

9. The cart of claim 8, further comprising a gate disposed between the cart compartment and the spreader compartment and moveable between an open position and a closed position, wherein in the open position the cart compartment and the spreader compartment define a contiguously connected compartment, and wherein in the closed position the cart compartment and the spreader compartment are disconnected.

10. The cart of claim 8, wherein the spreader comprises at least a second spreader wheel defining a pair of spreader wheels with the at least one spreader wheel, wherein each spreader wheel is coupled to the spreader device.

11. The cart of claim 8, wherein the spreader device comprises a spreader drum extending a width of the bottom portion and rotatably disposed in the bottom portion.

12. The cart of claim 11, wherein the spreader drum is defined by a plurality of radially spaced apart and laterally extending spreader blades.

13. The cart of claim 8, further comprising a retractable stand disposed proximate the rear of the cart.

14. An attachment for a cart having a cart compartment with an openable rear end, the attachment comprising:
a spreader compartment defined by a pair of opposed side walls, each side wall having a rear portion and a front portion, and a back wall extending between the rear portions of the side walls;
a spreader drum disposed in the bottom portion and rotatably coupled to the side walls; and
a pair of spreader wheels, each spreader wheel coupled to an end of the drum;
wherein the front portions of the side walls are configured to couple to a rear end of the cart to provide a contiguous compartment defined by the cart compartment and the spreader compartment when the rear end of the cart is opened.

15. The attachment of claim 14, wherein each spreader wheel comprises a plurality of radial spikes.

16. The attachment of claim 14, wherein the spreader device comprises a spreader drum extending a width of the bottom portion and rotatably disposed in the bottom portion.

17. The attachment of claim 16, wherein the spreader drum is defined by a plurality of radially spaced apart and laterally extending spreader blades.

18. The attachment of claim 14, further comprising a retractable stand.

19. The attachment of claim 14, further comprising an apron disposed between a floor of the cart compartment and the bottom portion of the spreader compartment.
